(19) United States
(12) Patent Application Publication
(10) Pub. No.: US 2010/0116820 A1
(43) Pub. Date: May 13, 2010

(54) INDUCTION ELECTRICAL APPLIANCE

(75) Inventors: Chih-Jung PAN, Taipei County (TW); Shun-Yung Chang, Taipei City (TW); Kuo-Liang Lee, Taipei City (TW); Chun Horn Kuo, Taipei City (TW); Ling-Chin Chao, Taipei City (TW)

Correspondence Address: RABIN & Berdo, PC, 1101 14TH STREET, NW, SUITE 500, WASHINGTON, DC, 20005, US

(73) Assignee: TSANN KUEN ENTERPRISE CO., LTD., Taipei City (TW)

(21) Appl. No.: 12/617,182

(22) Filed: Nov. 12, 2009

(30) Foreign Application Priority Data
Nov. 12, 2008 (TW) 097220271

(51) Int. Cl. H05B 6/12

(52) U.S. Cl. 219/624

(57) ABSTRACT

An induction electrical appliance comprising: a first shell, a first pan, a first heating element used fro heating the first pan and a first induction coil. The first shell detachably connected to the first pan, the food can be placed on the first grilling surface of the first pan, the first heating surface of the first pan fixedly connected to a first heating element, which is electrically connected to the induction coil. Thereby, the induction coil generates inducted current by extra magnetic field and inputs the current to the first heating element. Thus the first heating element can generate higher heat energy, and further enlarger the cooking temperature range of the first pan. Moreover, the cooking temperature can be adjusted according to the different food to let the food be more delicious.

### FIELD OF THE INVENTION

The present invention relates to an induction electrical appliance, more particularly, to an induction electrical appliance which generates power by the electromagnetic induction of extra magnetic.

### PRIOR ART

Referring to FIG. 1, generally, an electrical appliance in prior art such as grill comprises an upper cover 1a, a lower cover 2a, two pans 4a and two electric heating tube 3a. One side edge of said upper cover 1a pivotally connected with one side edge of said lower cover 2a, said two electric heating tubes 3a disposed inside said upper cover 1a and said lower cover 2a respectively, said two pans 4a fixedly connected to said upper cover 1a and said lower cover 2a respectively for placing food. When a current flows through the two electric heating tubes 3a, the resistance wire inside said the two electric heating tubes 3a is heated to generate heat energy to heat the two pans 4a, thus the food is cooked.

However, limited by the security regulations of household current, the abovementioned electrical appliance in prior art can not get higher current, thus it only can cook the food in a relatively lower temperature. Therefore, due to the lower cooking temperature, on one hand, the cooking time is long relatively, and the use energy is increased, on the other hand, it can not select a relatively higher cooking temperature according to different food, and the taste of the food is effected.

### SUMMARY OF THE INVENTION

The primary object of the present invention is to provide an induction electrical appliance, which can generate higher heat energy by the electromagnetic induction of extra magnetic to enlarger the range of the cooking temperature, thereby the users can select optimal cooking temperature according to the food material to let the food be more delicious.

To achieve the abovementioned object, the present invention provides an induction electrical appliance comprising: a first shell disposed with a bottom base; a first pan detachably connected to said first shell; a first heating element fixedly connected to said first pan; and an induction coil fixedly connected to said bottom base, said induction coil electrically connected to said first heating element.

The present invention has the following advantages:

Firstly, the induction coil produces inducted current by extra magnetic field, the inducted current heat said first heating tube and heat the first pan. Thereby, the food can be cooked by the heat generated by the way of magnetic induction.

Secondly, the current value of the induced current generated by the induction coil is related to the material, the circle number and arrangement of the induction coil, and a current higher than the household current can be provided. Thereby, higher current produces higher heat energy, the warm-up time of the first pan and the cooking time of food is shortened, and the energy is saved.

Thirdly, higher heat energy rise the cooking temperature of first pan and the cooking temperature range is enlarged. Thereby, the cooking temperature can be adjusted according to the different food to let the food more delicious.

The present invention will be apparent in its technical content and effect to be achieved after reading the detailed description of the preferred embodiment thereof in reference to the accompanying drawings.

### BRIEF DESCRIPTION OF THE DRAWINGS

FIG. 1 is a perspective view of an electrical appliance of prior art;

FIG. 2 is a sectional view of the induction electrical appliance of the present invention;

FIG. 3 is an exploded view of the induction electrical appliance of the present invention.

FIG. 4 is a block/schematic diagram of induction electrical appliance with an electric platform of the present invention;

FIG. 5A to 5G illustrate the use state of the induction electrical appliance cooperated with the electric platform of the present invention.

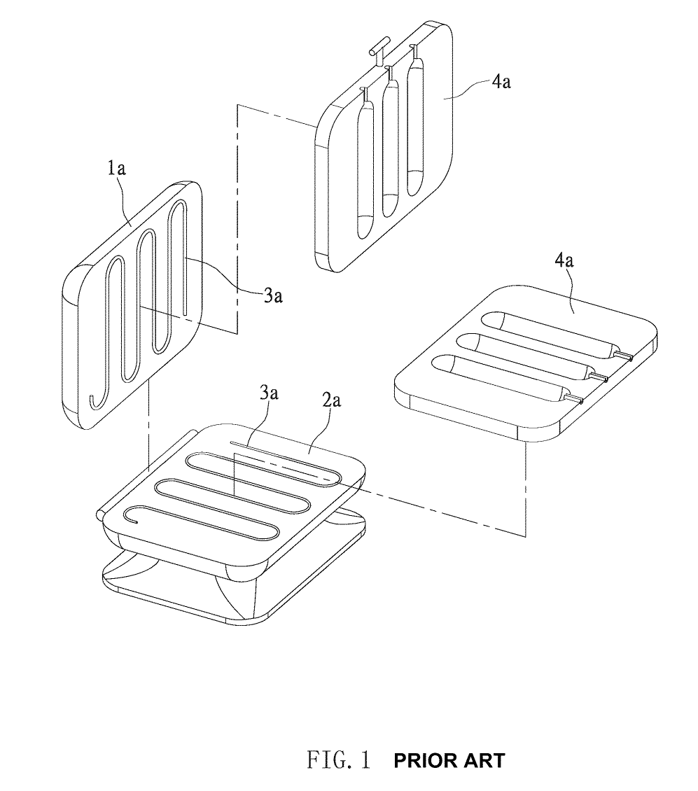

In these figures

| | |
|---|---|
| upper cover 1a | |
| lower cover 2a | |
| electrical heating tube 3a | |
| pan 4a | |
| first shell 1 | |
| bottom base 11 | first containing chamber 12 |
| clamping portion 13 | fixing portion 14 |
| first pan 2 | |
| first grilling surface 21 | first heating surface 22 |
| first heating element 3 | |
| second shell 4 | |
| upper base 41 | second containing chamber 42 |
| groove 43 | handle 44 |
| second pan 5 | |
| second grilling surface 51 | second heating surface 52 |
| second heating element 6 | |
| induction coil 7 | |
| induction fixing disc 71 | |
| electric control module 8 | |
| RF reception and emission module 81 | |
| Temperature detecting circuit 82 | identification chip 83 |
| AC/DC power module 84 | |
| energy-storing circuit 85 | |
| electric platform 9 | |
| driving module 91 | |
| RF reception and emission module | |
| of the electric platform 92 | |
| Induction coil of the electric | |
| platform 93 | |
| AC power 94 | |
| coffee maker 10 | |
| electric kettle 11 | |
| blender appliance 12 | |
| bread maker 13 | |
| electric cooker 14 | |
| electric iron 15 | |

### PREFERRED EMBODIMENT OF THE INVENTION

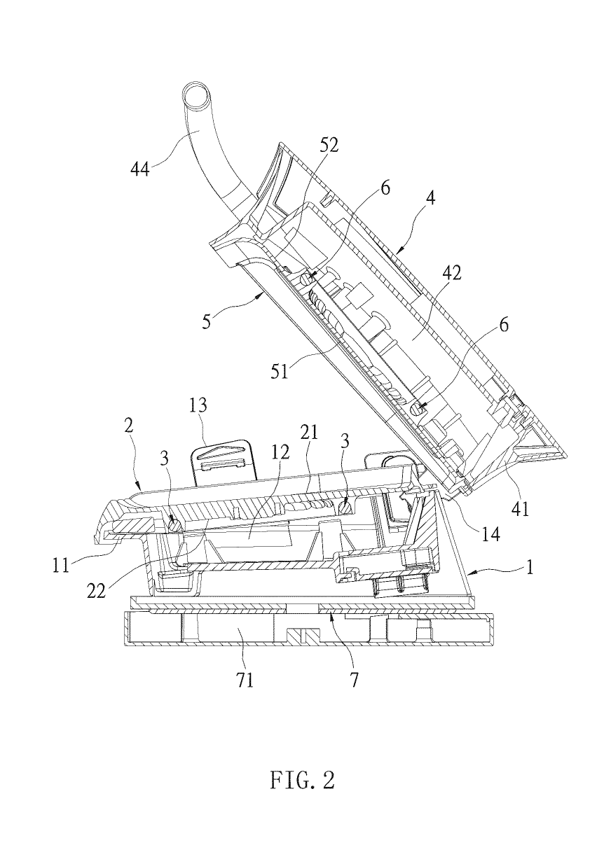

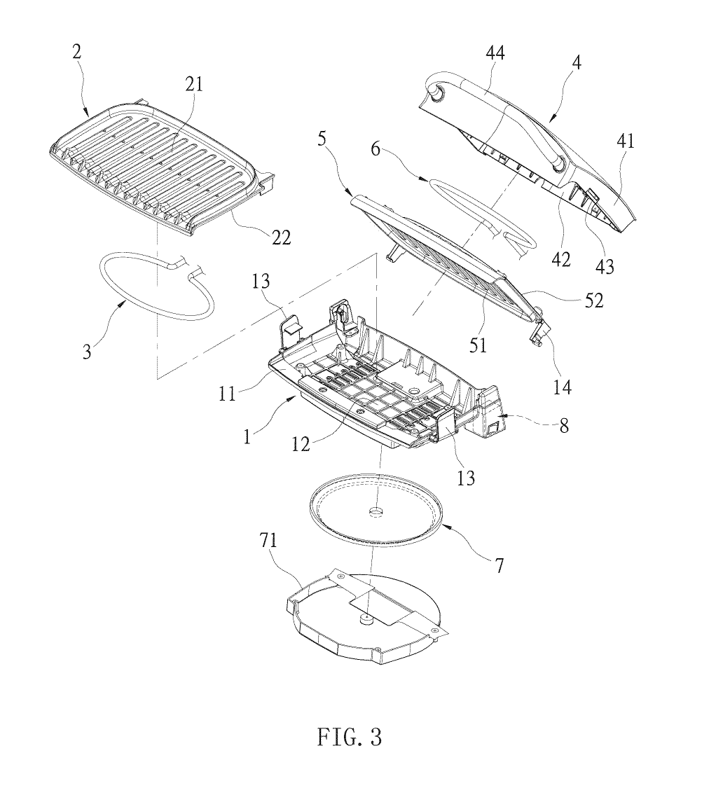

Referring to FIG. 2 and FIG. 3, the induction electrical appliance of the present is a grill comprising: a first shell 1 disposed with a bottom base 11 and a first containing chamber 12 formed by the inner wall of said first shell 1. Each of the two sides of the bottom base 11 has a clamping portion 13, a first pan 2 is disposed on the top of first base 11, the first pan 2 is fixedly connected to the first shell 1 by a pair of fixing portions 14, the first pan 2 can be easily detached from the first shell 1 to be cleaned. One side of the first pan 2 has a first grilling surface 21 for placing food, the opposite side has a first heating surface 22, said first heating surface 22 is fixedly connected to a first heating element 3 disposed inside the first containing chamber. A induction coil 7 is disposed in the bottom of the bottom base 11 of the first shell 1, said induction coil can be placed on a coil fixing disc 71 and fixedly connected to the bottom of the bottom base 11, said induction coil 7 electrically connected to the first heating element 3.

One side of the first shell 1 pivotally connected to one side of a second shell 4 via the fixing portion 14 so that said second shell 4 can be covered on the first shell 1 or arranged with the first shell 1 side by side. The second shell 4 has an upper base 41 and a second containing chamber 42 surrounded by the inner wall of the second shell 4

A handle 44 is mounted on one side of the upper base 41, and the two sides of the upper base 41 has a pair of grooves 43 which are corresponding to the clamping portions 13, when the second shell 4 is covered on the first shell 1, the two clamping portions 13 coupled with the two grooves 43. A second pan 5 is disposed on one side of the upper base 41, the second pan 5 is fixedly connected to the second shell 4 by the fixing portions 14, the second pan 5 can be easily detached from the second shell 4 to be cleaned. One side of the second pan 5 has a second grilling surface 51 for placing food, the opposite side has a second heating surface 52, said second heating surface 52 is fixedly connected to a second heating element 6 disposed inside the second containing chamber 42. Said second heating element 6 is a heating tube and electrically connected to the first heating element 3.

If disposed in an extra magnetic field, the induction coil 7 will react with the extra magnetic field and generate induced current, the induced current flow through the first heating element 3 to heat the resistance inside the first heating element 3 so as to produce heat energy, the heat energy is transferred to the first pan 2 by heat transfer effect, the temperature of the first grilling surface 21 of the first pan 2 is rise to cook the food. While the second heating element 6 electrically connected to the first heating element 3, the induction current also will flow through the second heating element 6, thus the second grilling surface 51 of the second pan 5 also can be used for cooking food.

In addition, the current value of the induced current generated by the induction coil 7 is related to the material, the circle number and arrangement of the induction coil 7, and a current higher than the household current can be provided. Thereby, higher current produces higher heat energy, the warm-up time of the first pan 2 and the second pan 5 and the time of cooking food can be shortened, thus the energy is saved. More over, higher heat energy rise the cooking temperature of first pan 2 and the second pan 5 and the cooking temperature range is enlarged. Thereby, the cooking temperature can be adjusted according to the different food to let the food to be more delicious.

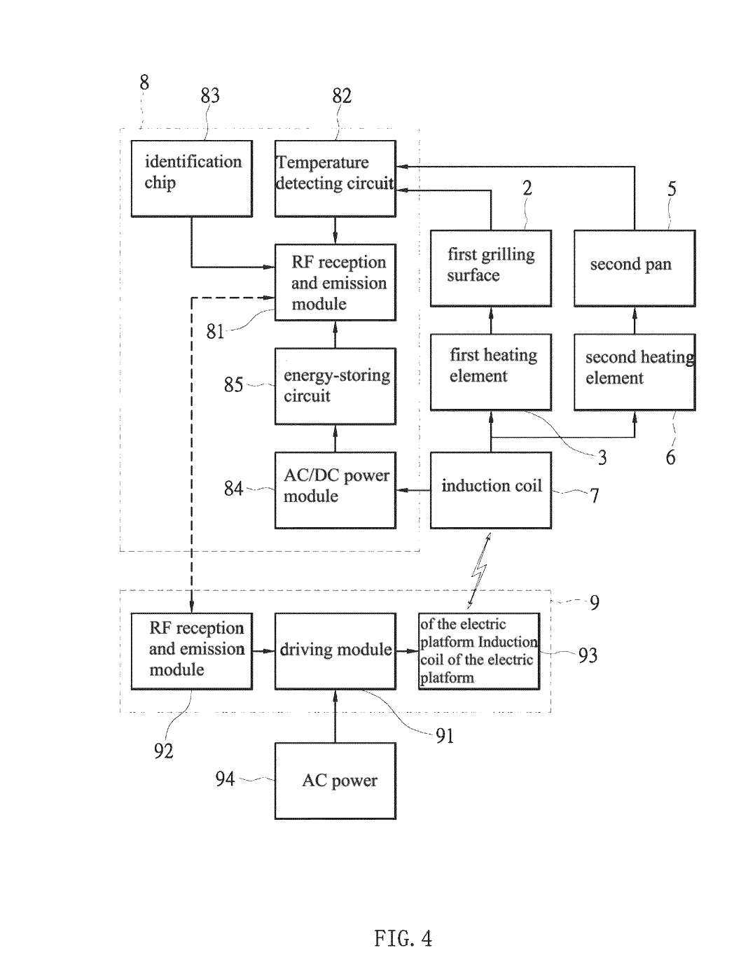

The base 11 of the first shell 1 further comprises an electric control module 8 (as is shown in FIG. 3), the electric control module 8 is well known in the art, so only the operating principle is described herein. The electric control module 8 has a RF reception and emission module 81 and a AC/DC power module 84 (as is shown in FIG. 4) The induced current generated by the induction coil 7 is transferred to direct current by the AC/DC power module 84, and the direct current is then output to an energy-storing circuit 85 which is the power source for the RF reception and emission module 81, the energy-storing circuit 85 also can store power for continuously providing power to the RF reception and emission module 81 to operate under the circumstance that there is not induced current. The RF reception and emission module 81 is also connected to a temperature detecting circuit 82 and an identification chip 83, the temperature detecting circuit 82 connected to the first grilling surface 21 and the second grilling surface 51, thus the temperature detecting circuit 82 can detect the temperature of the first grilling surface 21 and the second grilling surface 51 and output a temperature parameter to the RF reception and emission module 81. Moreover, the RF reception and emission module 81 also can receive the identifier generated by the identification chip 83.

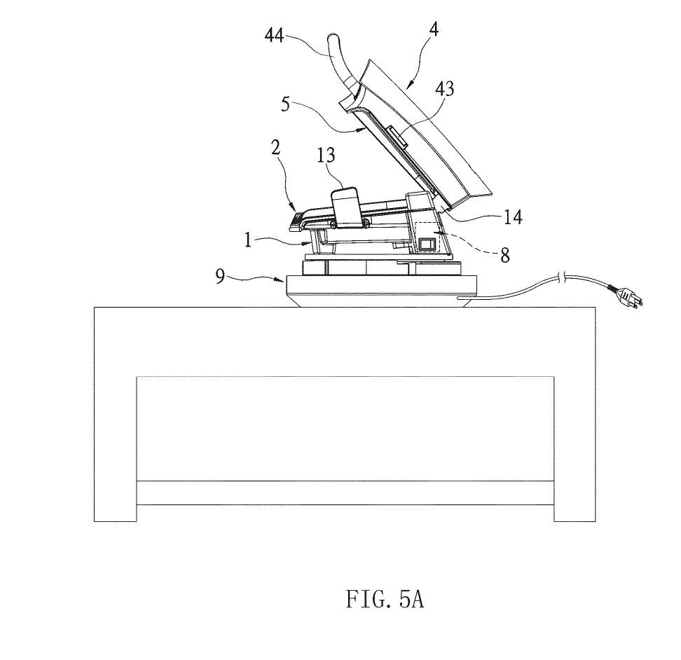

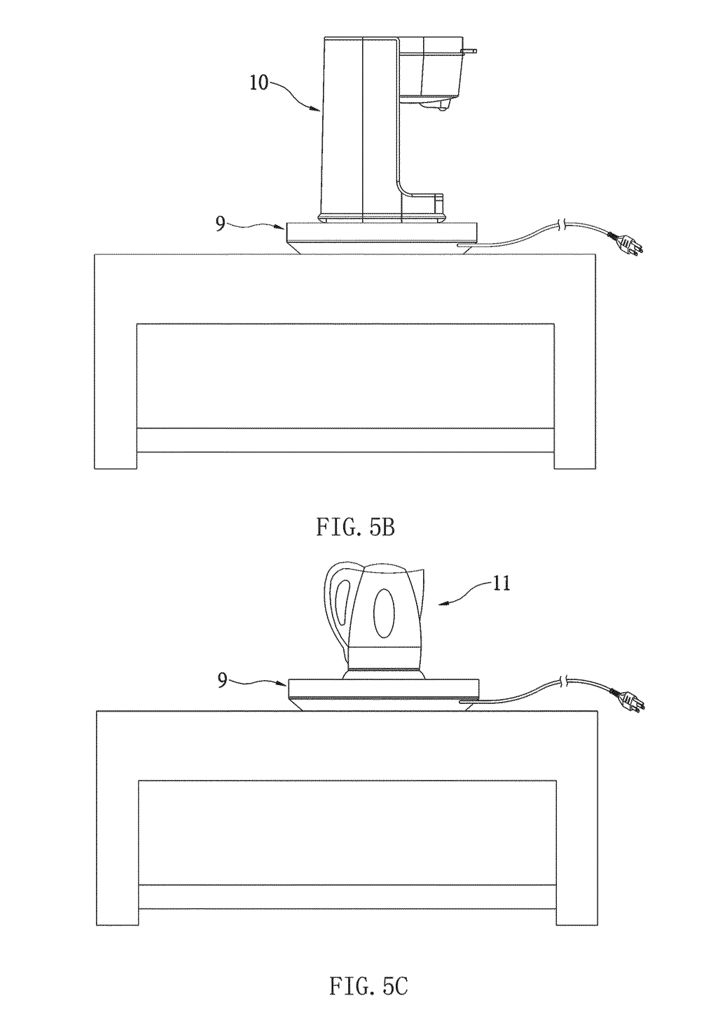

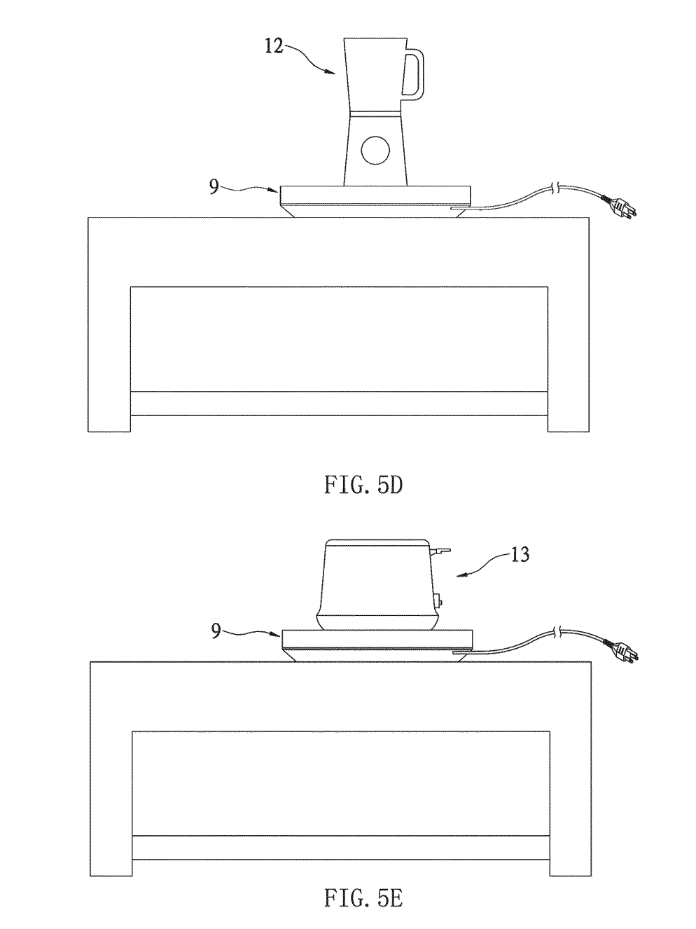

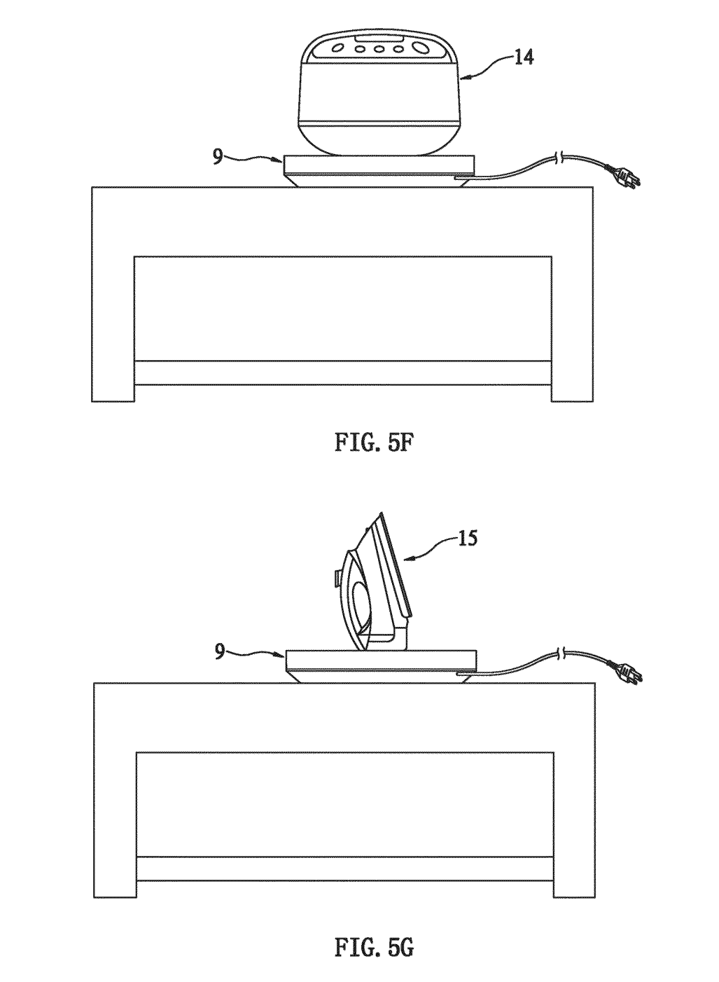

In use, the induction electrical appliance of the present invention is placed on an electric platform 9 (as shown in FIG. 5A), the electric platform 9 has a RF reception and emission module 92 (as shown in FIG. 4) which can transfer and receive information to the RF reception and emission module 81, said information comprises temperature parameter and identifier. After being received the temperature parameter and identifier, the RF reception and emission module 92 of the electric platform output an electrical signal to a driving module 91, the driving module 91 is electrically connected to an AC power 94, and the driving module 91 can determinate to provide the alternating current produced by the AC power 94 to an induction coil 93 of the electric platform or not according to the electrical signal. When the alternating current flow through the induction coil 93 of the electric platform, time-varying electromagnetic field is generated, the induction coil 7 react with the time-varying electromagnetic field to generate induced current, then the induced current is output to the first heating element 3 and the second heating element 6 to heat the resistance inside the first grilling element 3 and the resistance inside the second heating element 6, thus the temperature of the first grilling surface 21 and the second grilling surface 51 is rise.

In summary, place the induction electrical appliance of the present invention on the electric platform 9 to use, the time-varying electromagnetic field of the induction coil 7 will react with that of the induction coil 93 of the electric platform to generate induced current, the induced current level can be determinate by the arrangement, the circle number and the material of the induction coil 7, thereby to provide a high power (about 3000 W) which is higher than the commercial power (1500 W) to improve the heating speed so as to shorten the time of cooking and save the energy. In addition, to determinate whether to continuously provide power according to the temperature of the first grilling surface 21 and the second grilling surface 51 in heating, the heating temperature is automatically controlled in a temperature range, thus the cooking temperature can be selected according to different food, so as to add the delicious taste of the food.

However, the induction electrical appliance of the present invention also can be used by placing on an induction cooker or an electric heat stove with high power, so that the induction coil 7 react with the extra magnetic field to achieve the abovementioned heating principle, and add the convenience of using the induction electrical appliance. Moreover, the first heating element 3 and the second heating element 6 of the present invention can be varied, the first heating element 3 and the second heating element 6 can be replaced by a driving element (not shown) such as a heater or a motor to electrically connected to the induction coil 7. thus the induction electrical appliance such as coffee maker 10, electric kettle 11, blender appliance 12, bread maker 13, electric cooker 14 and electric iron 15 (referring to FIG. 5B to FIG. 5G) can be placed on the electric platform 9, to provide a high power which is higher than the commercial power to improve efficiency of the induction electrical appliance.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An induction electrical appliance comprising:
a first shell disposed with a bottom base;
a first pan detachably connected to said first shell;
a first heating element fixedly connected to said first pan; and
an induction coil fixedly connected to said bottom base, and electrically connected to said first heating element.

2. The induction electrical appliance according to claim 1, wherein the induction electrical appliance is grill.

3. The induction electrical appliance according to claim 2, wherein said bottom base comprising an electric control module disposed with a temperature detecting circuit electrically connected to said first pan, an identification chip and a RF module electrically connected to said temperature detecting circuit and said identification chip respectively.

4. The induction electrical appliance according to claim 3, wherein said electric control module further comprising a AC/DC power module and an energy-storing circuit, one end of said AC/DC power module electrically connected to said induction coil and the other end electrically connected to said energy-storing circuit; said energy-storing circuit electrically connected to said RF module.

5. The induction electrical appliance according to claim 4, wherein the induction electrical appliance further comprising a second shell provided with a upper base, a second heating element electrically connected to said first heating element and a second pan fixedly connected to said second heating element, wherein one side of said second shell pivotally connected to said first shell and said second shell detachably connected to said second pan.

6. The induction electrical appliance according to claim 5, wherein said first heating element and said second heating element are electric heating tube.

7. An induction electrical appliance comprising:
a first shell disposed with a base;
a driving element disposed in said base; and
an induction coil fixedly connected to said base and electrically connected to said driving element.

8. The induction electrical appliance according to claim 7, wherein said base comprising an electric control module disposed with an identification chip and a RF module electrically connected to said identification chip.

9. The induction electrical appliance according to claim 8, wherein said electric control module further comprising a AC/DC power module and an energy-storing circuit, one end of said AC/DC power module electrically connected to said induction coil, and the other end electrically connected to said energy-storing circuit, said energy-storing circuit electrically connected to said RF module.

10. The induction electrical appliance according to claim 9, wherein said driving element is a heater.

11. The induction electrical appliance according to claim 10, wherein said induction electrical appliance is grill, coffee maker, electric kettle, bread maker, electric cooker or electric iron.

12. The induction electrical appliance according to claim 9, wherein said driving element is a motor.

13. The induction electrical appliance according to claim 12, wherein said induction electrical appliance is blender appliance.
